(19) United States
(12) Patent Application Publication
(10) Pub. No.: US 2021/0382971 A1
(43) Pub. Date: Dec. 9, 2021

(54) BATTERY MANAGEMENT SYSTEM AND BATTERY MANAGEMENT METHOD

(71) Applicant: PANASONIC INTELLECTUAL PROPERTY MANAGEMENT CO., LTD., Osaka-shi, Osaka (JP)

(72) Inventors: Hiromitsu EBISU, Tokyo (JP); Toshiya ZAITSU, Tokyo (JP); Hiroki SHINOHARA, Kanagawa (JP); Masashi TAKEMURA, Kanagawa (JP); Kenichiro SHIBASAKI, Kanagawa (JP); Koji AOTO, Hyogo (JP)

(73) Assignee: Panasonic Intellectual Property Managment Co., Ltd., Osaka-shi, Osaka (JP)

(21) Appl. No.: 17/290,663

(22) PCT Filed: Sep. 25, 2019
(86) PCT No.: PCT/JP2019/037704

§ 371 Date: Apr. 30, 2021

(30) Foreign Application Priority Data
Nov. 2, 2018 (JP) 2018-207717

(51) Int. Cl. G06F 21/32; B60L 53/80; B60L 53/65; G06K 9/00

(52) U.S. Cl. CPC G06F 21/32; G06K 9/00288; B60L 53/65; B60L 53/80

(57) ABSTRACT

The time and effort of the user when exchanging batteries can be minimized, and security can be sufficiently ensured in user authentication. A battery exchanger (3) is provided with a camera (11) for capturing an image of a visitor, and a management server (4) performs face verification to determine if the visitor is an authentic user according to face image information of the visitor acquired from the image captured by the camera. Based on the face verification result, the management server determines if battery exchange is permitted, and notifies the determination result to the battery exchanger. Further, based on identification information of the battery pack brought in by the visitor, the management server performs battery verification to determine if the battery pack brought in by the visitor is permitted to be exchanged, and based on the result of the battery verification, determines if the battery exchange should be permitted.

### TECHNICAL FIELD

The present invention relates to a battery management system and a battery management method for managing battery devices that are being served in a battery exchange service where users of electric vehicles exchange battery devices at battery stations.

### BACKGROUND ART

In recent years, electric vehicles such as electric motorcycles have attracted attention from the viewpoint of solving the problems of air pollution due to exhaust gas and fuel cost. In such an electric vehicle, the cruising ranges are extended due to the improvement in the performance of the battery devices, but there still is the inconvenience that the need for recharging the battery devices prevents the vehicles to be operated for prolonged periods of time.

Therefore, in order to eliminate such an inconvenience, there have been growing use of battery exchange services in which electric vehicles are fitted with detachable battery devices, and the depleted battery devices are exchanged with fully charged battery devices at battery stations so that the vehicles may be enabled to travel for prolonged periods of time.

A conventionally known technique for such a battery exchange service performs user authentication when exchanging the battery so that the battery exchange service can be made available only to pre-registered persons (see Patent Document 1). According to this technique, identification information of the electric vehicle used by each user is registered at the time of user registration, and the identification information (specific information) of the electric vehicle is stored in the battery device when the battery device is mounted on the electric vehicle. A battery exchange device (managing device) acquires the identification information of the electric vehicle from the returned battery device, and determines if the person who has returned the battery device is an authentic user or not.

### PRIOR ART DOCUMENT(S)

### Patent Document(S)

Patent Document 1: JP6322744B1

### SUMMARY OF THE INVENTION

### Task to be Accomplished by the Invention

In the case of an electric vehicle equipped with two battery devices, in order to replace the two battery devices, the user is required to hold the two battery devices removed from the electric vehicle in both hands to bring them into the battery exchange device. At this time, since both hands of the user are full, it is desired that the user can be authenticated without performing any manual operation.

In order to meet such a need, in the conventional technology, the user authentication is performed only by returning the battery devices to the battery exchange device, so that the user is not required to perform any particular operation. Therefore, the user's time and effort when exchanging the battery devices can be minimized.

However, according to the conventional technique, the user authentication is performed by using the identification information of the electric vehicle. Therefore, the battery exchange can be performed even by someone who is not an authentic user as long as the electric vehicle is registered. This is not adequate from the view point of security.

In view of such a problem of the prior art, a primary object of the present invention is to provide a battery management system and a battery management method that can reduce the time and effort of the user when exchanging battery devices, and can ensure a high level of security in user authentication.

### Means to Accomplish the Task

To achieve such an object, the present invention provides a battery management system, comprising: a plurality of battery devices for use in a battery exchange service; a plurality of battery exchange devices positioned in respective battery stations, and configured to store and charge the battery devices that are returned by users and to rent the charged battery devices to the users in exchange for the returned battery devices; and a server device connected to the battery exchange devices via a network, and configured to manage exchange of the battery devices at the battery exchange devices, wherein each battery exchange device is provided with a camera for capturing images of visitors, and the server device is configured to perform a face verification to determine if each visitor is an authentic user according to face image information of the visitor acquired from the captured image of the camera, to determine if a battery exchange should be performed according to a result of the face verification, and to notify a determination result for the battery exchange to the battery exchange device.

The present invention further provides a battery management method for managing a plurality of battery devices that are offered for a battery exchange service, comprising: capturing an image of each visitor by using a camera provided in a battery exchange device positioned in a battery station to store and charge the battery devices that are returned by users and to rent the charged battery devices to the users in exchange for the returned battery devices; and performing a face verification to determine if each visitor is an authentic user according to face image information of the visitor acquired from the captured image of the camera, and determining if a battery exchange should be performed according to a result of the face verification, and notifying a determination result for the battery exchange to the battery exchange devices in a server device connected to the battery exchange devices via a network, and configured to manage exchange of the battery devices at the battery exchange devices.

### Effect Of The Invention

According to the present disclosure, since face verification is performed as user authentication, the user is not required to perform any special operation so that the user's effort at the time of battery exchange can be minimized, and an adequate level of security for user authentication can be ensured.

### BRIEF DESCRIPTION OF THE DRAWING(S)

FIG. 1 is an overall block diagram of a battery sharing system according to a first embodiment of the present invention;

FIG. 2 is a simplified block diagram showing the structure of a battery exchanger 3, a management server 4 and a registration terminal 5 of the first embodiment;

FIG. 3 is an explanatory diagram showing the outline of the processes executed by the registration terminal 5 and the management server 4 of the first embodiment at the time of user registration;

FIG. 4 is a flow chart showing the operation procedure performed by the registration terminal 5 and the management server 4 of the first embodiment at the time of user registration;

FIG. 5 is an explanatory diagram showing the outline of the processes executed by the battery exchanger 3 and the management server 4 of the first embodiment at the time of battery exchange;

FIG. 6 is a flowchart of the operation procedure performed by the battery exchanger 3 and the management server 4 of the first embodiment at the time of battery exchange;

FIG. 7 is a flowchart of the operation procedure performed by the battery exchanger 3 and the management server 4 of a modification of the first embodiment at the time of battery exchange;

FIG. 8 is a simplified block diagram showing the structure of a battery exchanger 3, a management server 4 and a registration terminal 5 of a second embodiment;

FIG. 9 is an explanatory diagram showing the outline of the processes executed by the registration terminal 5 and the management server 4 of the second embodiment at the time of user registration;

FIG. 10 is a flow chart showing the operation procedure performed by the registration terminal 5 and the management server 4 of the second embodiment at the time of user registration;

FIG. 11 is an explanatory diagram showing the outline of the processes executed by the battery exchanger 3 and the management server 4 of the second embodiment at the time of battery exchange; and

FIG. 12 is a flowchart of the operation procedure performed by the battery exchanger 3 and the management server 4 of the second embodiment at the time of battery exchange.

### DESCRIPTION OF THE PREFERRED EMBODIMENT(S)

To achieve such an object of the present invention, the first aspect of the present invention provides a battery management system, comprising: a plurality of battery devices for use in a battery exchange service; a plurality of battery exchange devices positioned in respective battery stations, and configured to store and charge the battery devices that are returned by users and to rent the charged battery devices to the users in exchange for the returned battery devices; and a server device connected to the battery exchange devices via a network, and configured to manage exchange of the battery devices at the battery exchange devices, wherein each battery exchange device is provided with a camera for capturing images of visitors, and the server device is configured to perform a face verification to determine if each visitor is an authentic user according to face image information of the visitor acquired from the captured image of the camera, to determine if a battery exchange should be performed according to a result of the face verification, and to notify a determination result for the battery exchange to the battery exchange device.

Since the face verification is performed as the user authentication, the user is not required to perform any special operation so that the user's effort at the time of battery exchange can be minimized, and the level of security for the user authentication can be sufficiently ensured.

According to a second aspect of the present invention, the server device is configured to perform a battery verification to determine if the battery device provided by the visitor is suitable for battery exchange according to identification information of the battery device provided by the visitor, and to determine if a battery exchange should be performed according to a result of the battery verification.

Thereby, when the visitor brings in a battery device that is not suitable for battery exchange, the battery exchange can be refused.

According to a third aspect of the present invention, the server device is configured to manage the battery devices by associating the users with the identification information of the battery devices that are rented to the users.

Thereby, any illegitimate attempt for battery exchange by a user can be detected.

According to a fourth aspect of the present invention, when the visitor is determined to be an authentic user in the battery verification, the server device determines if the battery device provided by the user is the battery device that is being rented to the authentic user, and if the battery device provided by the user is not the battery device that is being rented to the user, refuses the battery exchange.

Since the battery exchange is not permitted when the user attempts an unauthorized battery exchange, an unauthorized battery exchange can be prevented.

According to a fifth aspect of the present invention, each battery device is affixed with a two-dimensional code image storing the identification information of the battery device on an outer surface thereof, the battery exchange device is provided with a camera for capturing an image of the battery device provided by each visitor, and the server device is configured to acquire the identification information of the battery device provided by the visitor by reading the two-dimensional code image acquired from the image captured by the camera.

Thereby, it can be determined if a battery exchange is permitted or not by identifying the battery device brought in by the visitor before the visitor actually returns the battery device to the battery exchange device.

According to a sixth aspect of the present invention, each battery exchange device is provided with a first camera for capturing an image of a face of each visitor, and a second camera for capturing an image of the battery device provided by the visitor.

Thereby, the images of the face of the visitor and the battery device can be both captured in an appropriate manner.

According to a seventh aspect of the present invention, each battery exchange device is provided with a shutter at an opening for storing and dispensing the battery device, and opening and closing of the shutter is controlled according to the determination result for the battery exchange by the server device.

Thereby, the returning of the battery device brought in by the visitor and the renting of the charged battery device can be selectively refused.

According to an eighth aspect of the present invention, each battery exchange device is configured to open the shutter upon detecting an approaching visitor to store the battery device provided by the visitor, and the battery exchange is refused by the server device, open the shutter to return the stored battery to the visitor.

It is thus possible to smoothly deal with the visitor when the battery exchange is not permitted.

According to a ninth aspect of the present invention, each battery exchange device is configured to open the shutter to store the battery device provided by the visitor when the battery exchange is permitted by the server device, and notify the visitor that the battery exchange is not permitted without opening the shutter when the battery exchange is refused by the server device.

It is thus possible to smoothly deal with the visitor when the battery exchange is not permitted.

A tenth aspect of the present invention provides a battery management method for managing a plurality of battery devices that are offered for a battery exchange service, comprising: capturing an image of each visitor by using a camera provided in a battery exchange device positioned in a battery station to store and charge the battery devices that are returned by users and to rent the charged battery devices to the users in exchange for the returned battery devices; and performing a face verification to determine if each visitor is an authentic user according to face image information of the visitor acquired from the captured image of the camera, and determining if a battery exchange should be performed according to a result of the face verification, and notifying a determination result for the battery exchange to the battery exchange devices in a server device connected to the battery exchange devices via a network, and configured to manage exchange of the battery devices at the battery exchange devices.

According to this arrangement, similarly to the first aspect of the present invention, it is possible to minimize the effort required for each user at the time of battery exchange, and the level of security for the user authentication can be sufficiently ensured.

Hereinafter, embodiments of the present invention are described in the following with reference to the appended drawings.

### First Embodiment

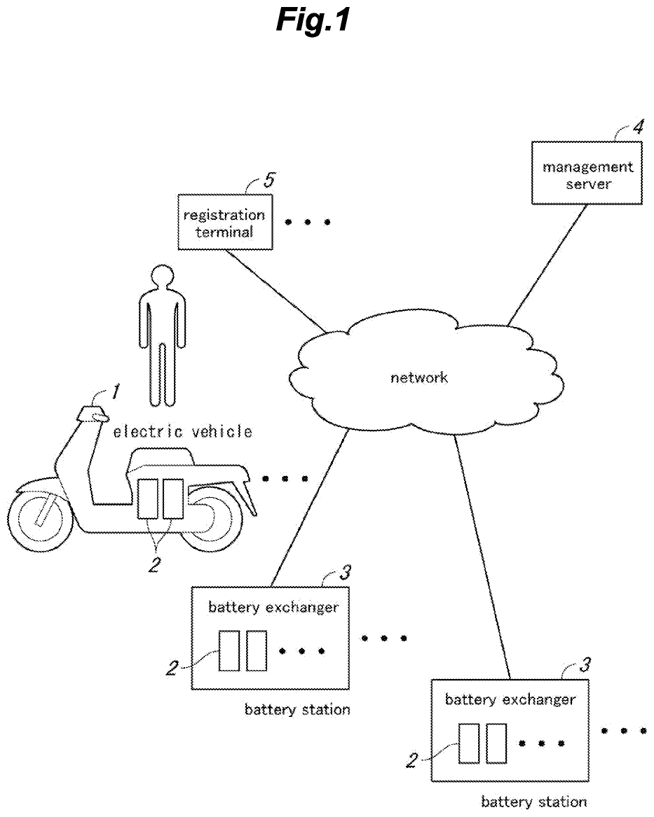

FIG. 1 is an overall structure diagram of a battery sharing system according to a first embodiment of the present invention.

This battery sharing system provides a service (battery exchange service) for sharing battery packs 2 (battery devices) to be mounted on electric vehicles 1 such as electric motorcycles, and includes battery exchangers 3 (battery exchange devices), a management server 4 (server device), and registration terminals 5 (terminal devices).

The battery exchangers 3, the management server 4, and the registration terminals 5 are connected to one another via a network such as the Internet. The battery exchangers 3 are network-connected to one another by wireless communication such as a mobile communication network and a wireless LAN.

Each electric vehicle 1 is equipped with a battery pack 2, and runs on the electric power of the battery pack 2. In the example shown in FIG. 1, the electric vehicles are electric motorcycles, but may also be four-wheeled vehicles. Further, the electric vehicles may also be mobility devices not intended for public roads such as electric wheelchairs, electric carts, and riding carts of a theme park or a golf course.

Each battery exchanger 3 stores and charges the battery packs 2 returned by the user, and rents the charged battery packs 2 to the users in exchange for the returned battery packs 2. The battery exchangers 3 are placed in battery stations attached to various facilities (shops) such as convenience stores and gas stations. A plurality of battery exchangers 3 may be installed in each battery station.

The management server 4 registers persons who subscribe to the battery exchange service to use the battery packs 2 as users (members), and manages the battery packs 2 and the users of the rented battery packs 2 in a mutually associated relationship.

The registration terminals 5 are installed in facilities that serve the users, and personnel in charge of the registration terminals perform user registration operations.

In the present embodiment, the battery packs 2 mounted on the electric vehicles 1 are given as an example, but the devices on which the battery packs 2 are mounted are not limited to electric vehicle, but may also be other devices such as portable power supply units.

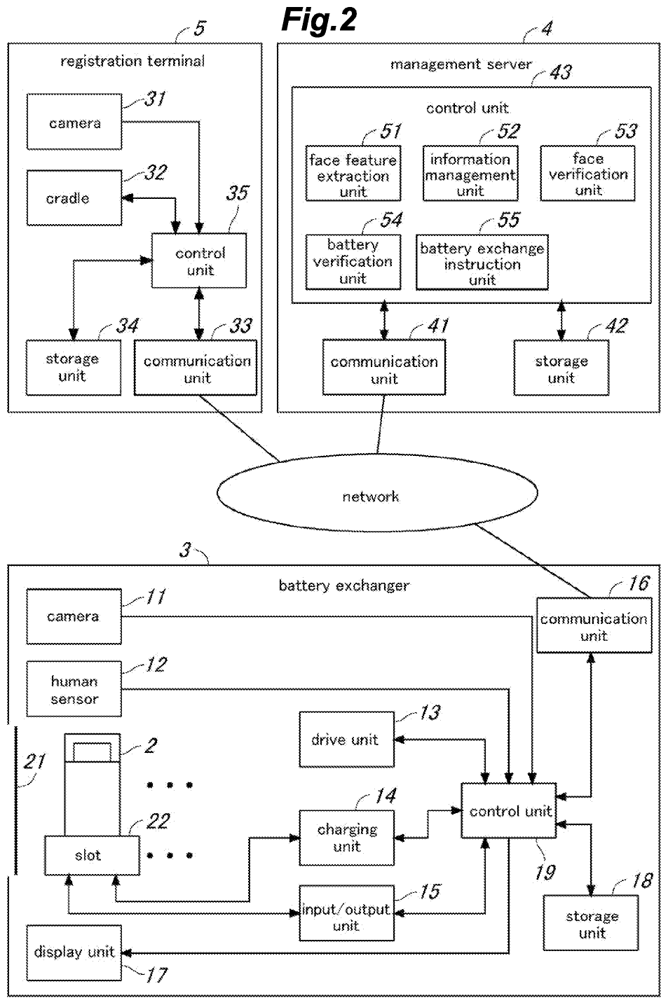

The overall structure of the battery exchanger 3, the management server 4, and the registration terminal 5 according to the first embodiment is described in the following. FIG. 2 is a block diagram schematically illustrating the overall structure of the battery exchanger 3, the management server 4, and the registration terminal 5.

The battery exchanger 3 includes a camera 11, a human sensor 12, a drive unit 13, a charging unit 14, an input/output unit 15, a communication unit 16, a display unit 17, a storage unit 18, and a control unit 19.

The camera 11 captures the image of a person (visitor) who has visited for battery exchange. In order to acquire the face image of the visitor with a high reliability, a plurality of cameras 11 may be arranged in the vertical direction so that the face image may be acquired without regard to the height of the visitor.

The human sensor 12 detects that a person has approached the battery exchanger 3.

In response to an instruction from the control unit 19, the drive unit 13 drives the opening/closing mechanism of a shutter 21 (opening/closing door) provided at the storing/dispensing opening of the battery pack 2 at the timing of returning and renting the battery pack 2, and, as the same time, drives a storing/dispensing mechanism that stores the returned battery pack 2 and dispenses the battery pack 2 to be rented to the user.

The charging unit 14 charges the battery packs 2 via respective slots 22 (trays).

The input/output unit 15 inputs/outputs information from/to the battery pack 2, and, for example, receives information on the identification number, the alert information and the deterioration information of each battery pack 2.

The communication unit 16 communicates with the management server 4 via a network.

The display unit 17 displays a guide screen regarding exchange of the battery packs 2.

The storage unit 18 stores a computer program executed by a processor that forms the control unit 19, and other data.

The control unit 19 is composed of a processor, and controls various parts of the battery exchanger 3. For example, when the human sensor 12 detects the approach of a person, the drive unit 13 is controlled to move an empty slot 22 to the storing/dispensing opening, and open the shutter 21 so that the user can return the battery pack 2. When an exchange permission notification is received from the management server 4, the control unit 19 moves the slot 22 containing the charged battery pack 2 ready to be rented to the user to the storing/dispensing opening, and opens the shutter 21 so that the user may receive the battery pack 2 to be rented to the user.

Further, the control unit 19 detects the face of the visitor from the captured image of the camera 11 to acquire the face image, and acquires an identification number from the returned battery pack 2 via the input/output unit 15. The control unit 19 then transmits the face image of the visitor and the identification number of the battery pack 2 from the communication unit 16 to the management server 4.

The registration terminal 5 includes a camera 31, a cradle 32, a communication unit 33, a storage unit 34, and a control unit 35.

The camera 31 captures the face image of the subject at the time of user registration.

At the time of user registration, the battery pack 2 that is to be rented to the user for the first time is placed in the cradle 32, and the cradle 32 reads the identification number of the battery pack 2.

The communication unit 33 communicates with the management server 4 via the network.

The storage unit 34 stores a computer program executed by the processor forming the control unit 35, and other data.

The control unit 35 is composed of a processor, and performs a process related to user registration. More specifically, the control unit 35 cuts out the face image of the subject from the image captured by the camera 31, acquires the identification number of the battery pack 2 via the cradle 32, and transmits the face image of the subject and the identification number of the battery pack 2 to the management server 4 via the communication unit 33.

The management server 4 includes a communication unit 41, a storage unit 42, and a control unit 43.

The communication unit 41 communicates with the battery exchanger 3 and the registration terminal 5 via the network.

The storage unit 42 stores registration information (user management information) in a user management table, a computer program executed by the processor forming the control unit 43, and other data.

The control unit 43 includes a face feature extraction unit 51, an information management unit 52, a face verification unit 53, a battery verification unit 54, and a battery exchange instruction unit 55. The control unit 43 is formed by a processor, and various parts of the control unit 43 are realized by executing the program stored in the storage unit 42 by the processor.

The face feature extraction unit 51 extracts face feature information from the face image of the user who is the subject of user registration acquired from the registration terminal 5 at the time of user registration. Further, the face feature extraction unit 51 extracts face feature information from the face image of the visitor acquired from the battery exchanger 3 at the time of battery exchange.

At the time of user registration, the information management unit 52 registers the face feature information of the subject acquired by the face feature extraction unit 51 and the identification number of the battery pack 2 acquired from the registration terminal 5 in the user management table. The user management table associates each battery pack 2 with the user to whom the battery is rented.

The face verification unit 53 performs a face verification to determine if the visitor is an authentic user by comparing the visitor's face feature information acquired by the face feature extraction unit 51 with the face feature information registered in the user management table at the time of battery exchange. In addition, since the user's face image is acquired every time the battery is exchanged, the face feature information extracted from the acquired face image may be used to update the user's face feature information registered in the user management table.

The battery verification unit 54 performs a battery verification to determine if the battery pack 2 returned to the battery exchanger 3 by the user is the same as the battery pack 2 rented to the user.

The battery exchange instruction unit 55 determines if battery exchange can be performed, and notifies the battery exchanger 3 of the determination result, or, in other words, if the battery exchange should be permitted to the battery exchanger 3. More specifically, when the face verification unit 53 has determined that the visitor is an authentic user, and the battery verification unit 54 has determined that the battery pack 2 returned by the user is the same as the battery pack 2 rented to the user, the communication unit 41 transmits an exchange permission notification permitting the battery exchange to the battery exchanger 3. If it is determined that the visitor is not an authentic user, or if the battery pack 2 returned by the user is different from the battery pack 2 rented to the user, the communication unit 41 transmits an exchange refusal notification to the battery exchanger 3 to refuse the battery exchange.

In this embodiment, the face feature extraction unit 51 was provided in the management server 4. However, the face feature extraction unit 51 may be provided in the registration terminal 5. Further, the face feature extraction unit 51 may be provided in the battery exchanger 3 so that only the face feature information extracted from the face image of the visitor be transmitted to the management server 4 via the network.

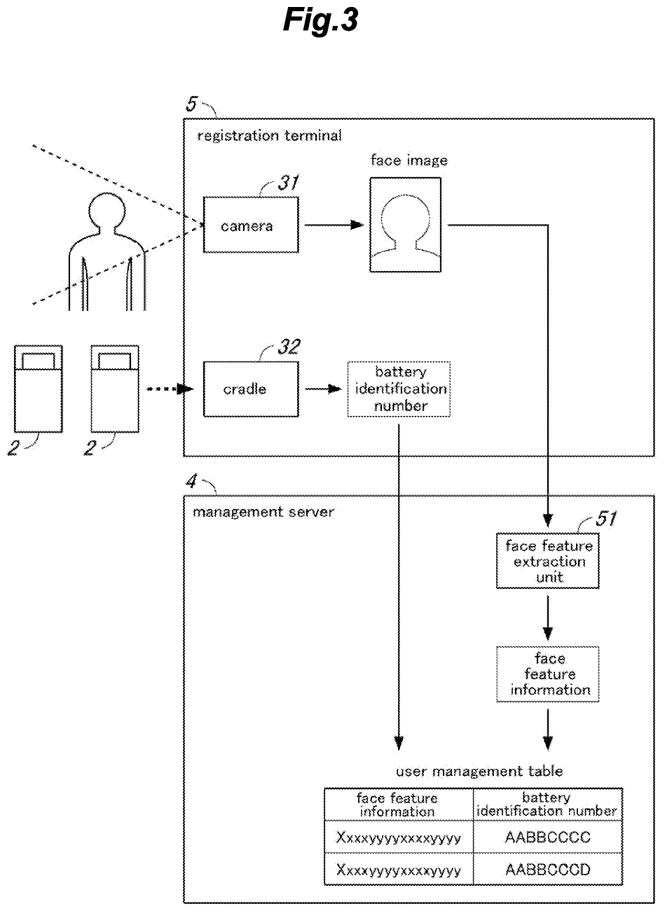

Next, the processes performed by the registration terminal 5 and the management server 4 at the time of user registration according to the first embodiment are described in the following. FIG. 3 is an explanatory diagram showing the outline of the processes performed by the registration terminal 5 and the management server 4 at the time of user registration.

In the present embodiment, when a new user subscribes to the battery exchange service to start using the battery pack 2, the person in charge performs the user registration operation at the registration terminal 5. At this time, the face of the subject or the new user is photographed by the camera 31 of the registration terminal 5, and the face image of the subject is acquired. Thereafter, the battery pack 2 to be rented to the user is placed on the cradle 32, and the identification number of the battery pack 2 is read. Then, the face image of the subject and the identification number of the battery pack 2 are transmitted to the management server 4.

In the management server 4, the face feature extraction unit 51 extracts face feature information from the face image of the subject, and the face feature information of the subject and the received identification number of the battery pack 2 are associated with each other and registered in the user management table.

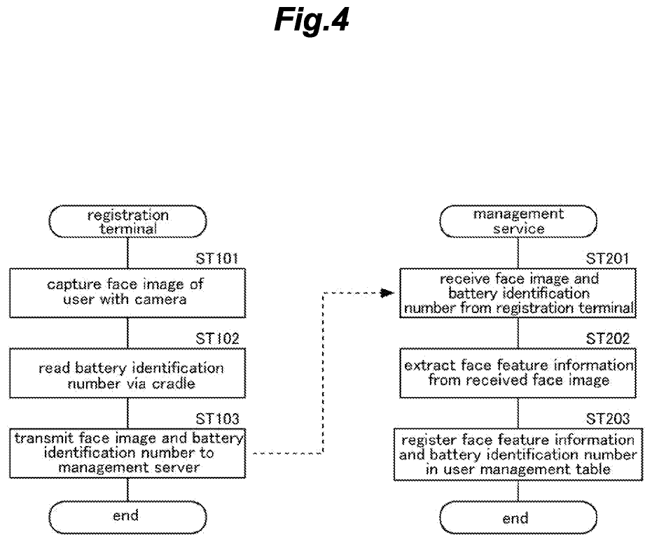

Next, an operation procedure at the time of user registration in the registration terminal 5 and the management server 4 according to the first embodiment is described in the following. FIG. 4 is a flowchart showing the operation procedure at the time of user registration in the registration terminal 5 and the management server 4.

In the registration terminal 5, first of all, the face image of the subject of the user registration is captured by the camera 31, and the face image of the subject is acquired (ST101). Further, the identification number of the rented battery pack 2 is read via the cradle 32 (ST102), and the face image of the subject and the identification number of the battery pack 2 are transmitted to the management server 4 (ST103).

When the management server 4 receives the face image of the subject and the identification number of the battery pack 2 transmitted from the registration terminal 5 (ST201), the face feature extraction unit 51 extracts the face feature information of the subject from the received face image (ST202). Then, the information management unit 52 registers the face feature information of the subject acquired by the face feature extraction unit 51 and the identification number of the battery pack 2 received from the registration terminal 5 in the user management table (ST203).

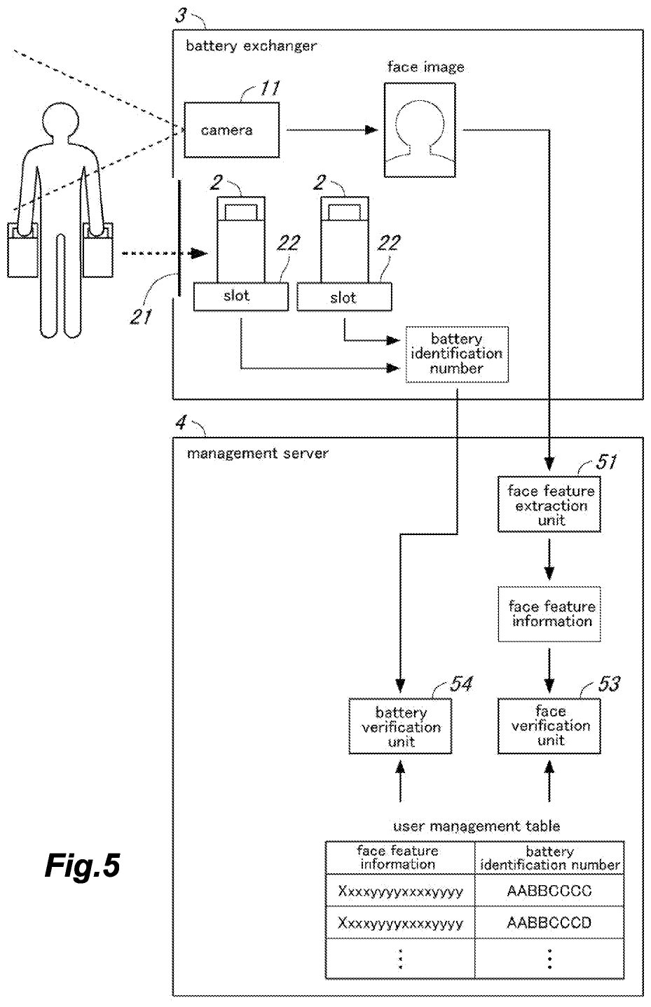

The processing performed at the time of battery exchange in the battery exchanger 3 and the management server 4 according to the first embodiment is described in the following. FIG. 5 is an explanatory diagram showing the outline of the processing performed at the time of battery exchange in the battery exchanger 3 and the management server 4.

In the battery exchanger 3, the face of a person (visitor) who has visited the battery station is photographed by the camera 11 to acquire the face image of the visitor. In the battery exchanger 3, the battery pack 2 brought in by the visitor is received by opening the shutter 21, and the identification number of the battery pack 2 is read through the slot 22 in which the battery pack 2 is placed. Then, the face image of the visitor and the identification number of the battery pack 2 are transmitted to the management server 4.

In the management server 4, the face feature extraction unit 51 extracts face feature information from the face image of the visitor. Then, the face verification unit 53 compares the face feature information of the visitor with the face feature information registered in the user management table to determine if the visitor is an authentic user. At this time, if any face feature information similar to the visitor's face feature information is found to be included in the face feature information registered in the user management table, the visitor is determined to be an authentic user.

Here, if the visitor is determined to be an authentic user, the battery verification unit 54 then determines if the battery pack 2 returned to the battery exchanger 3 by the user is the same as the battery pack 2 rented to the user. At this time, if the identification number of the battery pack 2 rented to the user registered in the user management table matches the identification number of the received battery pack 2, the battery pack 2 returned by the user is determined to be the battery pack 2 rented to the user.

Here, if it is determined that the battery pack 2 returned by the user is the same as the battery pack 2 rented to the user, the battery exchange is permitted.

If the user exchanged the battery pack 2 without going through the battery exchanger 3 or the shop such as when the user has directly exchanged the battery pack 2 with another user, the battery pack 2 returned by the user is different from the battery rented to the user so that the battery exchange is not permitted. In such a case, the management server 4 displays an error screen regarding the illegitimate battery exchange on the display unit 17 of the battery exchanger 3, and also displays a contact to which an inquiry should be made regarding the restoration of the battery exchange status.

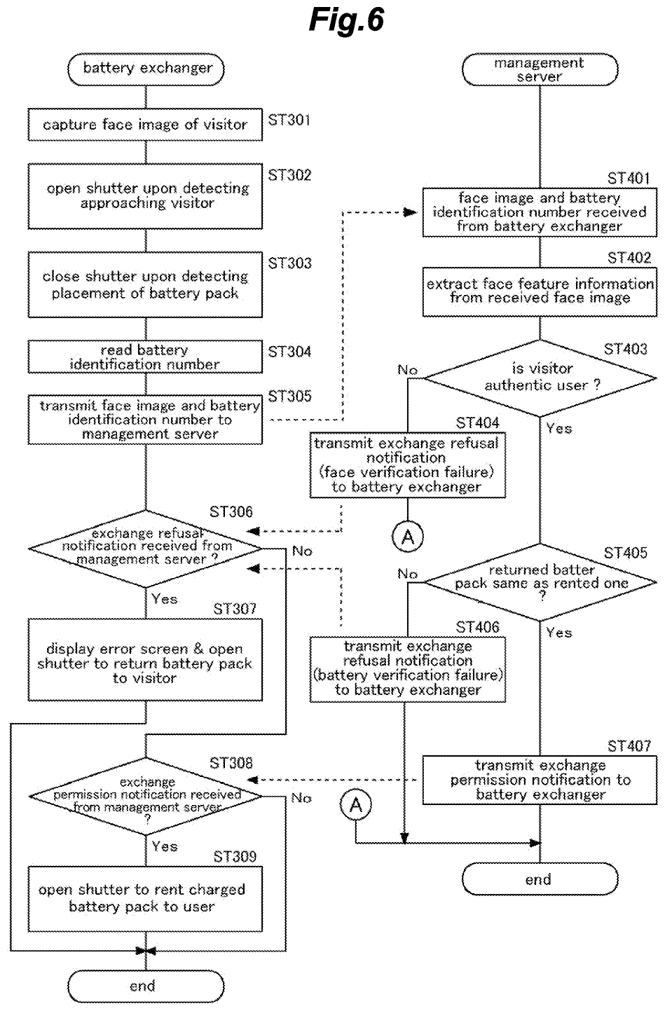

Next, the operation procedure at the time of battery exchange in the battery exchanger 3 and the management server 4 according to the first embodiment is described in the following. FIG. 6 is a flow chart showing the operation procedure at the time of battery exchange in the battery exchanger 3 and the management server 4.

In the battery exchanger 3, first of all, the image of the visitor is captured by the camera 11, and the face image of the visitor is acquired (ST301). Next, the shutter 21 is opened in response to a detection of a visitor by the human sensor 12 (ST302). Thereby, the visitor can return the battery pack 2 to the battery exchanger 3.

Next, the shutter 21 is closed in response to detecting that the battery pack 2 has been returned (ST303), and the identification number of the battery pack 2 is read (ST304). Thereafter, the face image of the visitor and the identification number of the battery pack 2 are transmitted from the communication unit 16 to the management server 4 (ST305).

In the management server 4, when the communication unit 41 has received the visitor's face image and the identification number of the battery pack 2 transmitted from the battery exchanger 3 (ST401), the face feature extraction unit 51 extracts the face feature information of the visitor from the received face image (ST402).

Next, the face verification unit 53 compares the face feature information of the visitor with the face feature information registered in the user management table to determine if the visitor is an authentic user (ST403).

If the visitor is not an authentic user (No in ST403), the communication unit 41 sends an exchange refusal notification to the battery exchanger 3 (ST404). At this time, the information that the face verification has failed, or the information that the visitor is not an authentic user is attached to the exchange refusal notice.

On the other hand, if the visitor is an authentic user (Yes in ST403), then the battery verification unit 54 determines if the battery pack 2 returned by the user to the battery exchanger 3 is the same as the battery pack 2 rented to the user (ST405).

If the battery pack 2 returned by the user is different from the battery pack 2 rented to the user (No in ST405), the communication unit 41 transmits an exchange refusal notification to the battery exchanger 3 (ST406). At this time, the fact that the battery verification has failed, or the information indicating that the user has illegitimately exchanged the battery is attached to the exchange refusal notice.

On the other hand, if the battery pack 2 returned by the user is the same as the battery pack 2 rented to the user (Yes in ST405), the communication unit 41 transmits an exchange permission notification to the battery exchanger 3 (ST407).

When the battery exchanger 3 has received the exchange refusal notice from the management server 4 (Yes in ST306), an error screen notifying the user that the battery pack 2 cannot be exchanged is displayed on the display unit 17, and opens the shutter 21 to return the battery pack 2 brought in by the visitor to the user (ST307).

Further, when the exchange permission notification is received from the management server 4 (Yes in ST308), the shutter 21 is opened to rent the charged battery pack 2 to the user (ST309).

When the charged battery pack 2 is rented to the user, the battery exchanger 3 transmits the identification number of the newly rented battery pack 2 to the management server 4, and the management server 4 updates the user management table with the identification number received from the battery exchanger 3.

### (Modification of First Embodiment)

A modification of the first embodiment is described in the following. This embodiment is similar to the previous embodiment unless otherwise specified.

In the first embodiment, when the battery verification fails, or when it is determined that the battery pack 2 returned by the user is different from the battery pack 2 rented to the user, the battery exchange is not permitted or refused. However, in this modification, even if the battery verification fails, as long as the battery pack 2 returned by the user is a genuine battery pack, or a battery pack 2 registered in advance as the object of the battery exchange service, the battery exchange is permitted, but the user is urged not to exchange the battery pack 2 in an improper manner.

If the identification number of the battery pack 2 is registered in the battery management list when the battery pack 2 is first put into service, it can be determined when the battery pack 2 is returned that the battery pack 2 is a genuine battery pack 2 based on the battery management list.

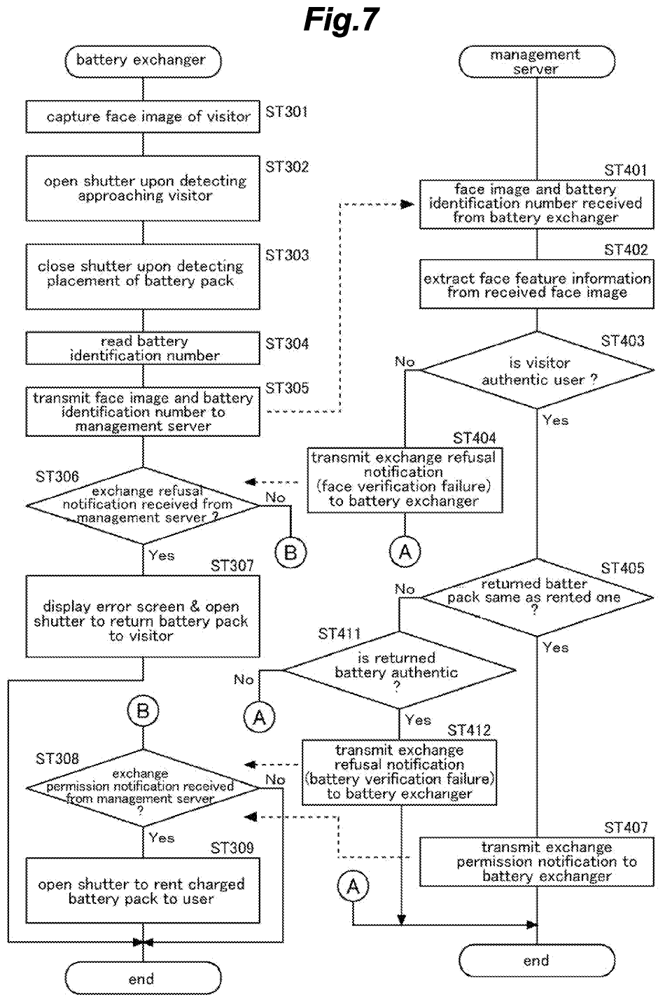

Next, the operation procedure at the time of battery exchange in the battery exchanger 3 and the management server 4 according to the modification of the first embodiment is be described in the following. FIG. 7 is a flowchart showing the operation procedure at the time of battery exchange in the battery exchanger 3 and the management server 4.

If it is determined that the battery pack 2 returned by the user is different from the battery pack 2 rented to the user (No in ST405) at the time of battery verification (ST405) performed by the battery verification unit 54, the management server 4 determines if the battery pack 2 returned by the user is a genuine battery pack 2 (a battery pack 2 that is the object of the battery exchange service) (ST411).

Here, if the battery pack 2 returned by the user is a genuine battery pack 2 (Yes in ST411), the communication unit 41 transmits an exchange permission notification to the battery exchanger 3 (ST412). At this time, information indicating that the battery verification has failed, or that the user has illegitimately exchanged the battery is attached to the exchange permission notification.

Upon receiving the exchange permission notification from the management server 4 (Yes in ST308), the battery exchanger 3 opens the shutter 21 to rent the charged battery pack 2 to the user (ST309). At this time, if the information indicating that the user has illegitimately exchanged the battery is attached to the exchange permission notification, a warning screen urging the user not to illegitimately exchange the battery pact 2 is displayed on the display unit 17.

In this conjunction, in order to manage the battery packs 2 to be properly rented to the users, the battery exchange service typically prohibits the users by a membership agreement from performing a battery exchange without the intervention of a battery exchanger 3 or an authorized shop, or from performing a battery exchange directly between users.

On the other hand, if an illegitimate battery exchange between the users is tolerated as long as the returned battery pack is a legitimate battery pack 2, the users not abiding by the membership agreement will be treated equally to the users abiding by the membership agreement so that the users may feel a lack of incentive to abide by the membership agreement.

Therefore, it is preferable to introduce a reward point program in order to motivate the users to comply with the membership agreement for the battery exchange service. More specifically, points (bonuses) are given to the user when the battery is properly exchanged by using the battery exchanger 3 or a shop, and points are not given to the user when the battery is improperly exchanged.

### Second Embodiment

Next, a second embodiment of the present invention is described in the following. This embodiment is similar to the previous embodiments unless otherwise specified.

In the previous embodiments, at the time of battery exchange, the identification number of the battery pack 2 is acquired after the user has returned the battery pack 2 to the battery exchanger 3. However, in the present embodiment, a two-dimensional code storing the identification number of the battery pack 2 is attached to the outer surface of the battery pack 2, and the image of the two-dimensional code of the battery pack 2 which is held by the user is captured when the user returns the battery pack 2 to the battery exchanger 3 so that the two-dimensional code may be read from the captured image, and the identification number of the battery pack 2 may be thereby acquired. The two-dimensional code may consist of a QR code (registered trademark), for example.

In the previous embodiments, the registration terminal 5 acquires the identification number of the battery pack 2 that is to be rented to the user after the battery pack 2 is mounted on the cradle 32 at the time of the user registration. However, in the present embodiment, the identification number of the battery pack 2 is obtained by capturing the image of the two-dimensional code of the rented battery pack 2, and reading the two-dimensional code from the captured image.

In this embodiment, the two-dimensional code is attached to the battery pack 2, and the identification number of the battery pack 2 is acquired by reading the two-dimensional code. Alternatively, the battery pack 2 may be fitted with an RFID (radio frequency identifier) tag so that the identification number of the battery pack 2 may be acquired by wireless communication.

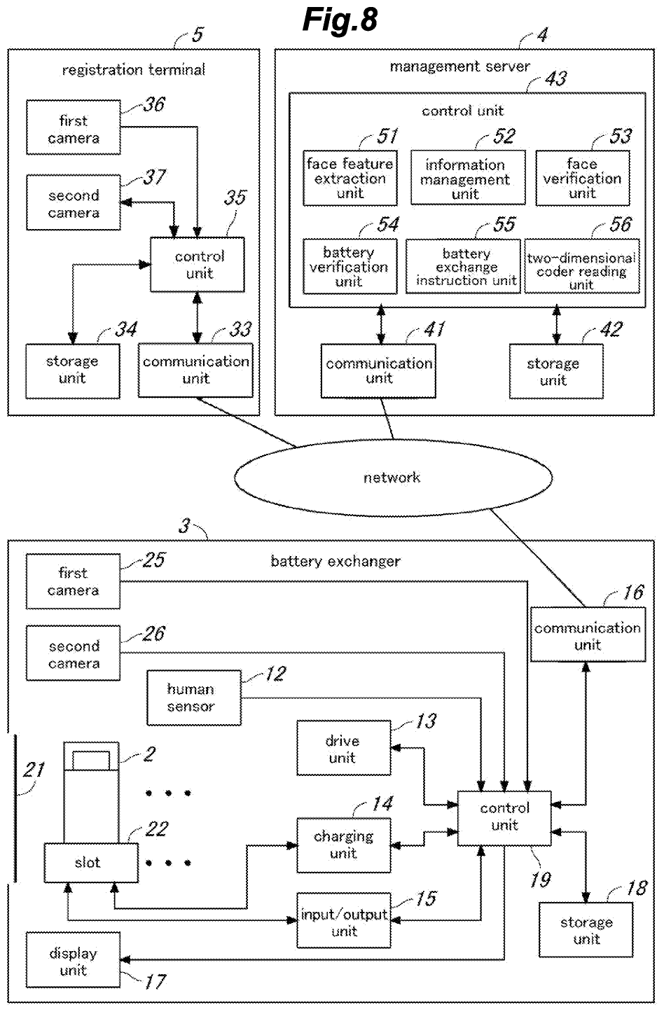

Next, the overall structure of the battery pack 2, the battery exchanger 3, and the management server 4 according to the second embodiment is described in the following. FIG. 8 is a block diagram schematically showing the overall structure of the battery pack 2, the battery exchanger 3, and the management server 4.

The battery exchanger 3 includes a first camera 25 and a second camera 26. The structure of the battery exchanger 3 is otherwise similar to that of the first embodiment (see FIG. 2).

The first camera 25, similarly to the camera 11 of the first embodiment, captures the face image of a person (visitor) who has visited for battery exchange. The second camera 26 captures the image of the two-dimensional code of the battery pack 2 brought by the visitor.

The registration terminal 5 includes a first camera 36 and a second camera 37. The structure of the registration terminal 5 is otherwise similar to that of the first embodiment (see FIG. 2).

The first camera 25, similarly to the camera 31 of the first embodiment, captures the face image of the user who is the subject of user registration. The second camera 37 captures the image of the two-dimensional code of the battery pack 2 that is rented to the user for the first time. The images of the face of the subject and the two-dimensional code of the battery pack 2 may be captured by a same camera.

The control unit 43 of the management server 4 includes a two-dimensional code reading unit 56. The second embodiment is otherwise similar to the first embodiment (see FIG. 2).

The two-dimensional code reading unit 56 reads the two-dimensional code image received from the battery exchanger 3, and acquires the identification number of the battery pack 2.

In this embodiment, the management server 4 is provided with the face feature extraction unit 51 and the two-dimensional code reading unit 56, but the registration terminal 5 may be provided with the face feature extraction unit and the two-dimensional code reading unit.

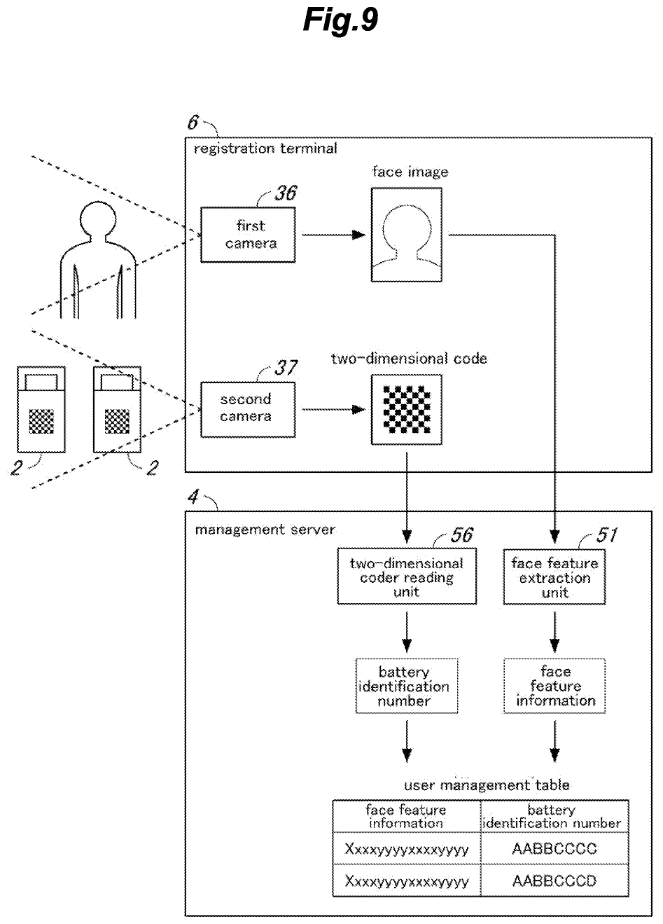

Next, the processes executed at the time of user registration in the registration terminal 5 and the management server 4 according to the second embodiment are described in the following. FIG. 9 is an explanatory diagram showing the outline of the processes performed at the time of user registration in the registration terminal 5 and the management server 4.

At the time of user registration, first of all, in the registration terminal 5, the face image of the subject is captured by the first camera 36, and the face image of the subject is acquired. In addition, the second camera 37 captures the image of a two-dimensional code attached to the rented battery pack 2. Then, the face image of the subject and the two-dimensional code image of the battery pack 2 are transmitted to the management server 4.

In the management server 4, the face feature extraction unit 51 extracts face feature information from the face image of the subject person, and the two-dimensional code reading unit 56 reads the two-dimensional code image to acquire the identification number of the battery pack 2. Furthermore, the face feature information and the identification number of the battery pack 2 are associated with each other, and registered in the user management table.

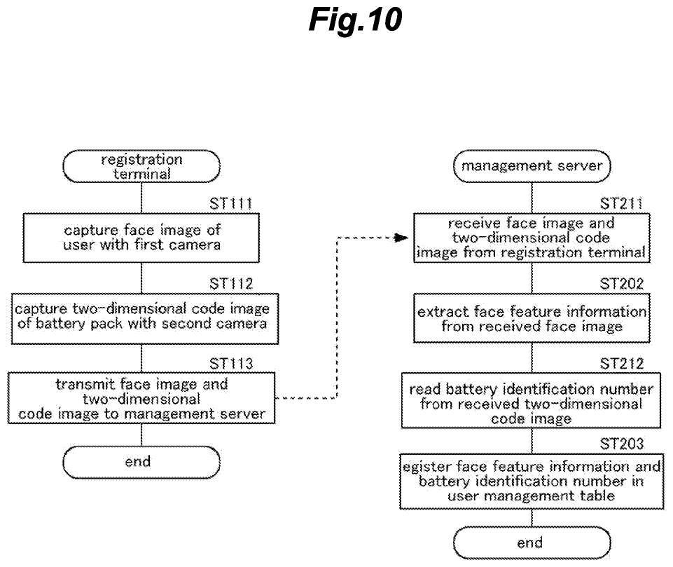

Next, the operation procedure at the time of user registration in the registration terminal 5 and the management server 4 according to the second embodiment is described in the following. FIG. 10 is a flowchart showing the operation procedure at the time of user registration in the registration terminal 5 and the management server 4.

In the registration terminal 5, first of all, the face image of the subject who is to be registered as a user is captured by the first camera 36, and the face image of the subject is acquired (ST111). In addition, the image of the two-dimensional code attached to the rented battery pack 2 is captured by the second camera 37 to obtain the two-dimensional code image of the battery pack 2 (ST112). Next, the face image of the subject and the two-dimensional code image of the battery pack 2 are transmitted from the communication unit 33 to the management server 4 (ST113).

In the management server 4, when the communication unit 41 receives the face image of the subject and the two-dimensional code image of the battery pack 2 transmitted from the registration terminal 5 (ST211), the face feature extraction unit 51 extracts the face feature information of the subject from the received face image (ST202). Further, the two-dimensional code reading unit 56 reads the received two-dimensional code image, and acquires the identification number of the battery pack 2 (ST212). Then, the face feature information of the subject and the identification number of the battery pack 2 are registered in the user management table (ST203).

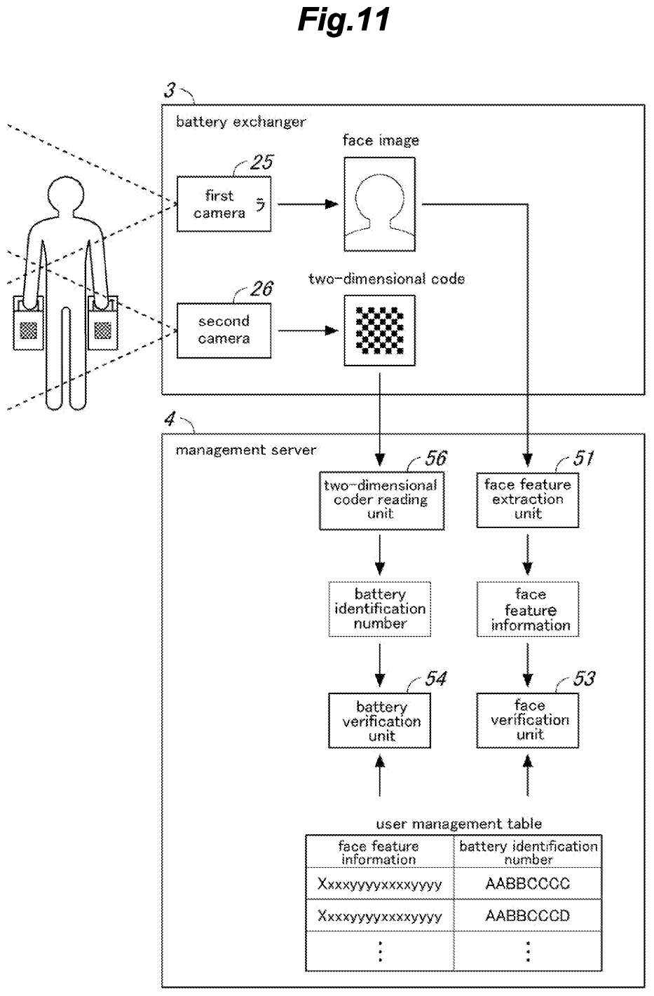

Next, the processes performed at the time of battery exchange in the battery exchanger 3 and the management server 4 according to the second embodiment are described in the following. FIG. 11 is an explanatory diagram showing the outline of processes performed at the time of battery exchange in the battery exchanger 3 and the management server 4.

When exchanging the battery, first of all, in the battery exchanger 3, the face image of the person (visitor) visiting the battery station is captured by the first camera 25 to acquire the face image of the visitor. Also, the image of the two-dimensional code attached to the battery pack 2 held by the visitor is captured by the second camera 26 to obtain a two-dimensional code image. Then, the face image of the visitor and the two-dimensional code image of the battery pack 2 are transmitted to the management server 4.

The first camera 25 and the second camera 26 are configured to have image capturing areas at different heights so that one of them captures the image of the visitor while the other one captures the image of the two-dimensional code of the battery pack 2. Furthermore, it is also possible to capture the images of the face of the visitor and the two-dimensional code of the battery pack 2 by using a single high-resolution camera.

In the management server 4, the face feature extraction unit 51 extracts the face feature information from the face image of the visitor. Then, the face verification unit 53 compares the face feature information of the visitor with the face feature information registered in the user management table to determine if the visitor is an authentic user.

Here, if the visitor is determined to be an authentic user, the two-dimensional code reading unit 56 then reads the two-dimensional code image and acquires the identification number of the battery pack 2. Then, the battery verification unit 54 determines if the battery pack 2 returned to the battery exchanger 3 by the user is the same as the battery pack 2 rented to the user.

If it is determined that the battery pack 2 returned by the user is the same as the battery pack 2 rented to the user, the battery exchange is permitted.

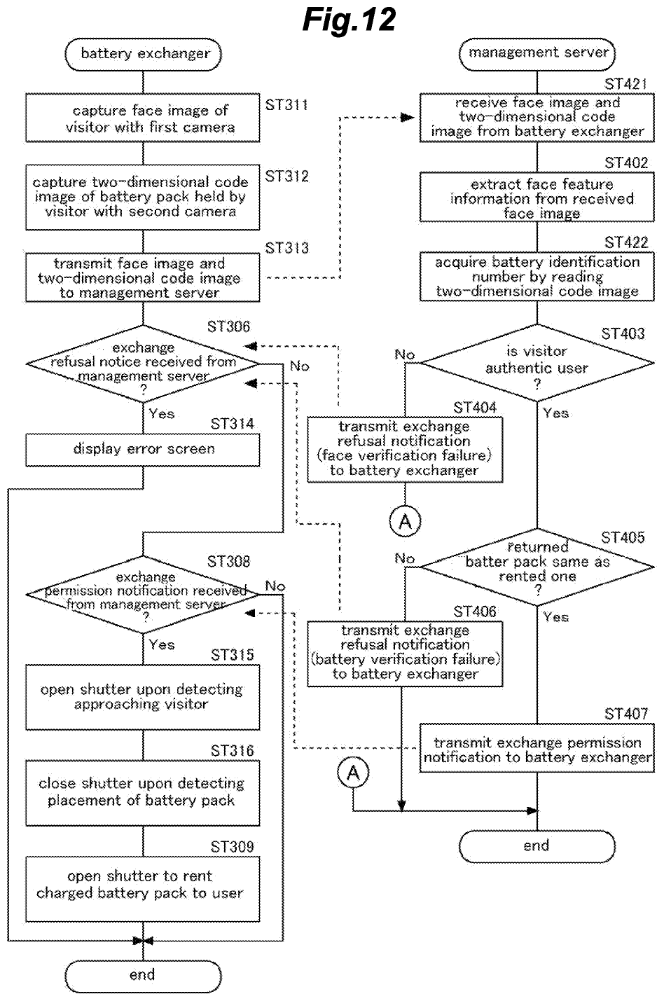

Next, an operation procedure at the time of battery exchange in the battery exchanger 3 and the management server 4 according to the second embodiment is described in the following. FIG. 12 is a flowchart showing the operation procedure at the time of battery exchange in the battery exchanger 3 and the management server 4.

In the battery exchanger 3, first of all, the face image of the visitor is acquired by capturing the face image of the visitor by the first camera 25 (ST311). Further, the image of the two-dimensional code attached to the battery pack 2 held by the visitor is captured by the second camera 26 to obtain the two-dimensional code image of the battery pack 2 (ST312). Then, the face image of the visitor and the two-dimensional code image of the battery pack 2 are transmitted from the communication unit 33 to the management server 4 (ST313).

In the management server 4, when the communication unit 41 receives the visitor's face image and the two-dimensional code image of the battery pack 2 transmitted from the battery exchanger 3 (ST411), first, the face feature extraction unit 51 extracts face feature information of the visitor from the received face image (ST402). Further, the two-dimensional code reading unit 56 reads the received two-dimensional code image and then acquires the identification number of the battery pack 2 (ST412).

Then, the face verification unit 53 compares the face feature information of the visitor with the face feature information registered in the user management table to determine if the visitor is an authentic user (ST403).

If the visitor is not an authentic user (No in ST403), the communication unit 41 sends an exchange refusal notification to the battery exchanger 3 (ST404). At this time, information that the face verification has failed, or the information that the visitor is not an authentic user is attached to the exchange refusal notice.

On the other hand, if the visitor is an authentic user (Yes in ST403), then the battery verification unit 54 determines if the battery pack 2 returned by the user to the battery exchanger 3 is the same as the battery pack 2 rented to the user (ST405).

If the battery pack 2 returned by the user is different from the battery pack 2 rented to the user (No in ST405), the communication unit 41 transmits an exchange refusal notification to the battery exchanger 3 (ST406). At this time, the fact that the battery verification has failed, or the information indicating that the user has illegitimately exchanged the battery pack is attached to the exchange refusal notice.

On the other hand, if the battery pack 2 returned by the user is the same as the battery pack 2 rented to the user (Yes in ST405), the communication unit 41 transmits an exchange permission notification to the battery exchanger 3 (ST407).

When the battery exchanger 3 receives the exchange refusal notice from the management server 4 (Yes in ST306), an error screen for notifying the user that the battery pack cannot be exchanged is displayed on the display unit 17 (ST314).

Further, when the exchange permission notification is received from the management server 4 (Yes in ST308), the shutter 21 is opened in response to the detection of an approaching person by the human sensor 12 (ST315). Thereby, the user can return the battery pack 2 to the battery exchanger 3. Next, the shutter 21 is closed in response to detecting that the battery pack 2 has been returned (ST316). Next, the shutter 21 is opened to rent the charged battery pack 2 to the user (ST309).

The present invention has been described in terms of embodiments given as examples of the technology disclosed in the present application. However, the technology contained in the foregoing disclosure is not limited to such embodiments, but can be applied to other embodiments in which changes, substitutions, additions, omissions, etc. are made to the disclosed embodiments. Further, it is also possible to combine the constituent elements described in the above-described embodiments to form new embodiments.

### INDUSTRIAL UTILITY

The battery management system and the battery management method shown in the foregoing disclosure have an effect of minimizing the user's time and effort that are required at the time of battery exchange, and adequately enhancing the level of security in user authentication. The presently disclosed invention is useful as a battery management system and a battery management method for managing battery devices in a battery exchange service by which users of electric vehicles or the like exchange battery devices at battery stations.

REFERENCE NUMERALS

| | |
|---|---|
| 1 electric vehicle | 2 battery pack (battery device) |
| 3 battery exchanger (battery exchange | |
| device) | |
| 4 management server (server device) | 5 registration terminal (terminal |
| | device) |
| 11 camera | 12 human sensor |
| 13 drive unit | 14 charging unit |
| 15 input/output unit | 16 communication unit |
| 17 display unit | 18 storage unit |
| 19 control unit | 21 shutter |
| 25 first camera | 26 second camera |
| 31 camera | 32 cradle |
| 33 communication unit | 34 storage unit |
| 35 control unit | 36 first camera |
| 37 second camera | 41 communication unit |
| 42 storage unit | 43 control unit |

1. A battery management system, comprising:
a plurality of battery devices for use in a battery exchange service;
a plurality of battery exchange devices positioned in respective battery stations, and configured to store and charge the battery devices that are returned by users and to rent the charged battery devices to the users in exchange for the returned battery devices; and
a server device connected to the battery exchange devices via a network, and configured to manage exchange of the battery devices at the battery exchange devices, wherein each battery exchange device is provided with a camera for capturing images of visitors, and
the server device is configured to perform a face verification to determine if each visitor is an authentic user according to face image information of the visitor acquired from the captured image of the camera, to determine if a battery exchange should be performed according to a result of the face verification, and to notify a determination result for the battery exchange to the battery exchange device.

2. The battery management system according to claim 1, wherein the server device is configured to perform a battery verification to determine if the battery device provided by the visitor is suitable for battery exchange according to identification information of the battery device provided by the visitor, and to determine if a battery exchange should be performed according to a result of the battery verification.

3. The battery management system according to claim 1, wherein the server device is configured to manage the battery devices by associating the users with the identification information of the battery devices that are rented to the users.

4. The battery management system according to claim 2, wherein when the visitor is determined to be an authentic user in the battery verification, the server device determines if the battery device provided by the user is the battery device that is being rented to the authentic user, and if the battery device provided by the user is not the battery device that is being rented to the user, refuses the battery exchange.

5. The battery management system according to claim 2, wherein each battery device is affixed with a two-dimensional code image storing the identification information of the battery device on an outer surface thereof,
the battery exchange device is provided with a camera for capturing an image of the battery device provided by each visitor, and
the server device is configured to acquire the identification information of the battery device provided by the visitor by reading the two-dimensional code image acquired from the image captured by the camera.

6. The battery management system according to claim 5, wherein each battery exchange device is provided with a first camera for capturing an image of a face of each visitor, and a second camera for capturing an image of the battery device provided by the visitor.

7. The battery management system according to claim 1, wherein each battery exchange device is provided with a shutter at an opening for storing and dispensing the battery device, and opening and closing of the shutter is controlled according to the determination result for the battery exchange by the server device.

8. The battery management system according to claim 7, wherein each battery exchange device is configured to open the shutter upon detecting an approaching visitor to store the battery device provided by the visitor, and when the battery exchange is refused by the server device, open the shutter to return the stored battery to the visitor.

9. The battery management system according to claim 7, wherein each battery exchange device is configured to open the shutter to store the battery device provided by the visitor when the battery exchange is permitted by the server device, and notify the visitor that the battery exchange is not permitted without opening the shutter when the battery exchange is refused by the server device.

10. A battery management method for managing a plurality of battery devices that are offered for a battery exchange service, comprising:
capturing an image of each visitor by using a camera provided in a battery exchange device positioned in a battery station to store and charge the battery devices that are returned by users and to rent the charged battery devices to the users in exchange for the returned battery devices; and
performing a face verification to determine if each visitor is an authentic user according to face image information of the visitor acquired from the captured image of the camera, and determining if a battery exchange should be performed according to a result of the face verification, and notifying a determination result for the battery exchange to the battery exchange devices in a server device connected to the battery exchange devices via a network, and configured to manage exchange of the battery devices at the battery exchange devices.
